(19) United States
(12) Patent Application Publication
(10) Pub. No.: US 2005/0194420 A1
(43) Pub. Date: Sep. 8, 2005

(54) Electromagnetically driven setting tool and method of driving same

(76) Inventors: Mario Zahner, Chur (CH); Ulrich Rosenbaum, Wangs (CH)

Correspondence Address: DAVID TOREN, ESQ.;ABELMAN FRAYNE & SCHWAB, 666 THIRD AVENUE, NEW YORK, NY, 10017-5621, US

(21) Appl. No.: 11/070,428

(22) Filed: Mar. 2, 2005

(30) Foreign Application Priority Data
Mar. 3, 2004 (DE) 10 2004 010 319.4

(51) Int. Cl. B25C 5/02

(52) U.S. Cl. 227/131; 173/117

(57) ABSTRACT

An electromagnetically driven setting tool for driving in fastening elements includes a magnetic anchor (14) displaceably arranged in a guide (13) located in the tool housing (11), a magnetic coil (12) arranged in the housing (11) for displacing the magnetic anchor (14) from an initial position (30) of the magnetic anchor (14) relative to the housing (11) into an end position (32), and a force accumulator (15) which becomes loaded by the magnetic anchor (14) when the magnetic anchor (14) is displaced by the magnetic coil (12) in a direction of the force accumulator (15) to its intermediate position (31), and which accelerates the magnetic anchor (14), upon unloading, in an opposite direction when the magnetic anchor (14) is displaced by the magnetic coil (12) from the intermediate position (31) to the end position (32).

### BACKGROUND OF THE INVENTION

1. Field of the Invention

The present invention relates to an electromagnetically driven setting tool for driving in fastening elements and including a housing, a guide arranged, at least partially, in the housing, a magnetic anchor, displaceably arranged in the guide, and a magnetic coil arranged in the housing for displacing the magnetic anchor from an initial position of the magnetic anchor relative to the housing into an end position in which the magnetic anchor drives a fastening element in. The present invention also relates to a method of driving such a setting tool.

2. Description of the Prior Act

Setting tools of the type described above are used for driving fastening elements, in particular by a single drive-in movement of a piston in an object, e.g., a constructional component.

In the electromagnetically driven tools, the piston is formed as a magnetically conducting anchor that is accelerated by a magnetic coil. The impact or drive-in energy amounts to about 7 J, dependent on a limitation of the acceleration path and the coil size.

A setting tool of the type disclosed above is described in a German Publication DE 3937794 A1. The setting tool has a coil arranged in a tool housing and a magnetic anchor driven by the coil. The coil is supported, at its end facing in a direction opposite the drive-in direction, against the housing by a spring that acts as a rebound damper. A tension spring, which is arranged between the supporting end of the housing and the magnetic anchor, is used for returning the magnetic anchor in its initial position after completion of a setting or drive-in process.

A drawback of the known setting tool consists in that it has a small impact or drive-in energy that is not always sufficient for driving a fastening element, e.g., a nail in a hardened construction component.

Accordingly, an object of the present invention is a setting tool of the type described above and a method of driving the same in which the foregoing drawback of the known tool is eliminated, and a high drive-in energy is provided in a technically simply way.

### SUMMARY OF THE INVENTION

This and other objects of the present invention, which will become apparent herein after, are achieved by providing a force accumulator which becomes loaded by the magnetic anchor when the magnetic anchor is displaced, in a first phase of a setting process, by the magnetic coil in a direction of the force accumulator to an intermediate position of the magnetic anchor relative to the housing, and which accelerates the magnetic anchor, in a second phase of the setting process, in an opposite direction when the magnetic anchor is displaced by the magnetic coil from the intermediate position to the end position.

With such force accumulator, which becomes loaded upon purposeful acceleration of the magnetic anchor or piston in the direction toward the force accumulator, the magnetic anchor is driven, during a single drive-in impact, upon changing the polarity of the magnetic coil, by both the magnetic coil and the force accumulator in the drive-in direction. There is provided, thus, in sum a noticeably higher drive-in energy per impact than in conventional electromagnetically driven setting tools.

Advantageously, there is provided, in the setting tool, a control device which applies, in the first phase of the setting process, a first polarity to the magnetic coil for accelerating the magnetic anchor in the direction of the force accumulator, and which applies, in the second phase of the setting process, a second polarity to the magnetic coil for accelerating the magnetic anchor in the opposite direction.

The control device which, e.g., is formed as an electrical circuit and which, e.g., can include a microprocessor can provide a precise control of the magnetic coil within few milliseconds, which makes a rapid succession of separate drive-in processes possible.

Advantageously, the force accumulator is formed as a compression spring having one of its ends fixedly secured to the housing with its opposite end adjacent to the magnetic anchor remaining free. With this arrangement, with which the spring can be brought in a direct contact with the magnetic anchor with its free end, energy looses, which can result from a further mechanical contact or fiction, are prevented.

Advantageously, the magnetic anchor is located, in its initial position, in a region of the guide which is substantially surrounded by the magnetic coil. Thereby, on one hand, a sufficient displacement path is provided between an end of the magnetic anchor adjacent to the force accumulator and the force accumulator. Thereby, a sufficient acceleration path is provided for the magnetic anchor. On the other hand, the opening of the magazine with fastening elements toward the guide remains unobstructed, which insures feeding of fastening elements into the guide. In order for the magnetic coil to apply a maximum force to the magnetic anchor before the magnetic anchor moves in the direction of the force accumulator, a mechanical holding element such as, e.g., a pawl can be provided and which would release the magnetic anchor only then when the field strength of the magnetic coil reaches its maximum.

However, the magnetic anchor can also be located, essentially, in a region of the guide remote from the force accumulator.

Advantageously, the magnetically anchor is formed as a piston so that it can act directly on a fastening element, without any energy-consuming intermediate elements arranged between the anchor and the fastening element.

Advantageously, there is provided restoring means for returning the anchor from its end position to its initial position. This permits to define the initial position using very simple means, e.g., the restoring means can be formed as a tension spring.

According to the inventive method, in a first phase of energization of the magnetic coil, i.e., in the first phase of the setting process, the magnetic anchor is displaced against the force accumulator, whereby the force accumulator is loaded. In the second phase of the energization of the magnetic coil, i.e., in the second phase of the setting process, when the polarity of magnetic field of the coil is reversed, the magnetic anchor is accelerated, as a result of unloading of the force accumulator, in the opposite direction, i.e., in the setting or drive-in direction.

With the inventive method, at which the magnetic anchor or piston, in a first phase, is accelerated in a direction opposite the drive-in or operational direction against the force accumulator, and is accelerated in the drive-in direction only in the second phase, a noticeably high impact or drive-in energy of the setting tool is achieved.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a longitudinal cross-sectional view of a setting tool according to the present invention in the initial position of the setting tool;

FIG. 2 a cross-sectional view of the setting tool shown in FIG. 1 in the intermediate position of the tool; and

FIG. 3 a cross-sectional tool shown in FIGS. 1-2 in the drive-in position of the tool.

### DETAILED DESCRIPTION OF THE PREFERRED EMBODIMENT

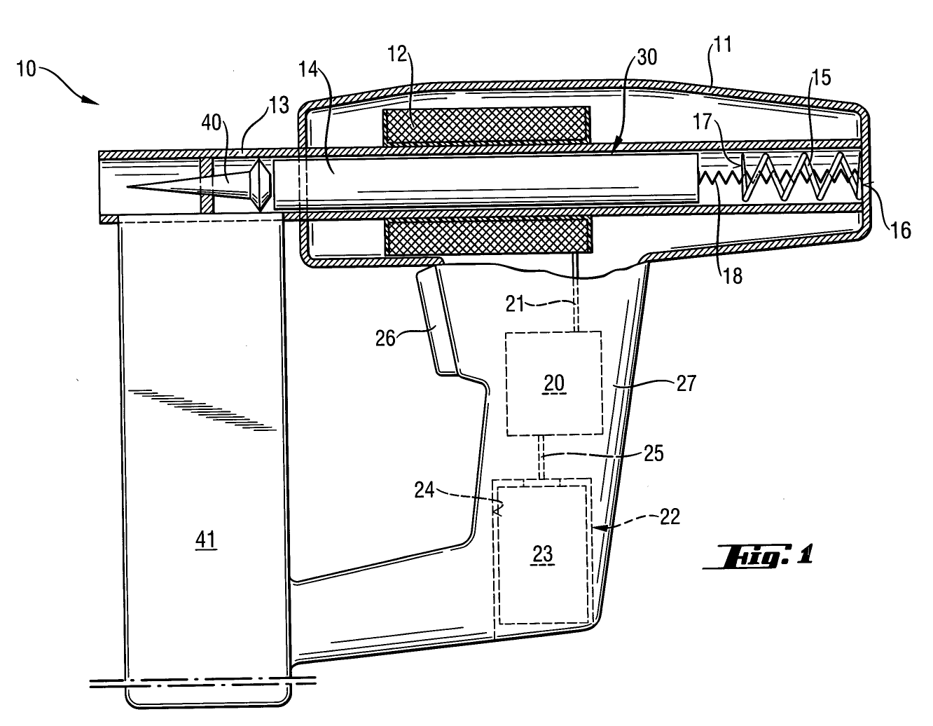

A setting tool 10 according to the present invention, which is shown in FIGS. 1-3, has a housing 11 and at least one magnetic coil 12 arranged in the housing 11. In the housing 12, there is further provided a guide 13 in which a magnetic anchor 14 which, e.g., is formed as a piston, is displaceably arranged. The guide 13 extends, at least region-wise, through the magnetic coil 12. At an end of the guide 13 facing in the drive-in direction, there is arranged a magazine 41 for fastening elements that projects sidewise form the drive-in end. In the magazine 41, fastening elements 40 are stored. At an end of the guide 13 remote from the magazine 41, there is provided a force accumulator 15 which is formed as a compression spring. The force accumulator 15 has one end 16 thereof fixedly secured to the housing 11 at the rear end of the guide 13, while the opposite end 17 of the force accumulator 15 remains free.

The setting tool is further provided with a handle 27 on which an activation switch 26 for initiation of a setting process with the setting tool 10 is arranged. In the handle 27, there is further arranged a current source, which is generally designated with a reference numeral 22, for supplying the setting tool 10 with electrical energy. The current source 22 includes one or more accumulators 23 which is (are) located in the accumulator receptacle 24. Electrical conductors 25 connect the accumulator(s) 23 with a control device 20 that is connected, in turn, with the magnetic coil 12 and, if necessary, with other consumers of the electrical power by electrical conductors 21. It should be understood that, alternatively, the electrical energy can be supplied from a network. In the initial position 30, which is shown in FIG. 1, the magnetic anchor 14 is located approximately in the middle of the guide 13 in the region of the magnetic coil 12 and is held in the position by restoring means 18 that is formed as a tension spring. However, the positioning of the magnetic anchor 14 and its return to its initial position 30 can be effected, e.g., with the magnetic coil 12 itself.

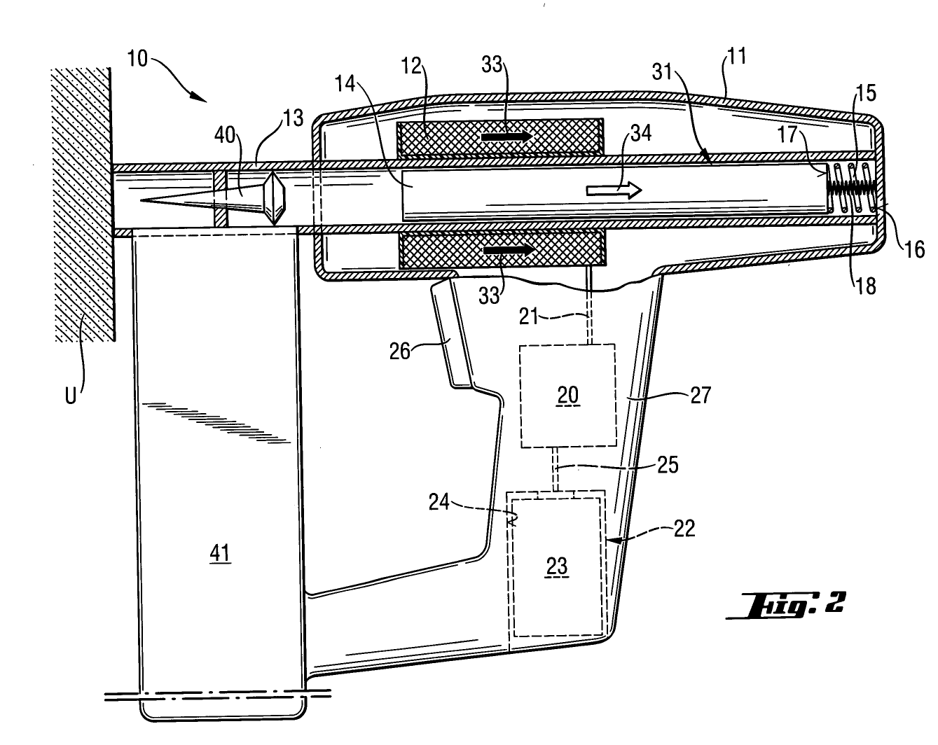

When the setting tool 10 is pressed against a constructional component U, as shown in FIG. 2, the actuation switch 26 is actuated by the tool operator and, in the first phase of the drive-in process, the control device 20 applies, via the electrical conductors 21, electrical voltage to the poles of the magnetic coils 12. This generates a first magnetic field in the magnetic coil 12 that, in turn, provides a first acceleration force in the direction of arrow 33 that acts on the magnetic anchor 14. The magnetic anchor 14 is, thereby, accelerated in the direction of arrow 33 against a biasing force of the force accumulator 15, the compression spring, loading the same.

In FIG. 2, the setting tool 10 is in its intermediate position 31, in which the force accumulator 15 is completely loaded. Upon reaching this position, the control device 20 reverses the polarity of the voltage applied to the magnetic coil 12 that, in turn, generates a magnetic field in a reverse polarity. This process can be effected by the control device 20 either upon expiration of a predetermined time period or after sensing the position of the magnetic anchor 14, e.g., with appropriate sensors or switches that can be provided on the guide 13.

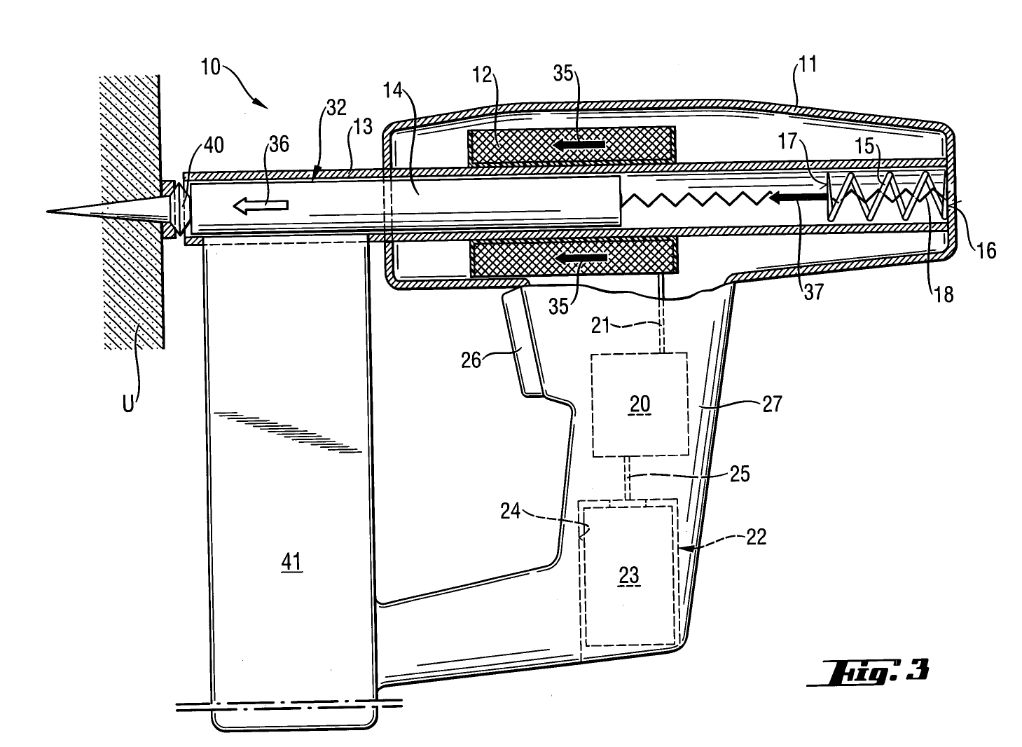

As a result of the reversed polarity of the magnetic field in the magnetic coil 12, an acceleration force in the direction of arrow 35 would act on the magnetic anchor 14 (see FIG. 3). To this acceleration force, an acceleration force, which is produced by the force accumulator 15 and acts in the direction 37, identical to the direction 36, will be added. As a result, the magnetic anchor 14 would be accelerated in the direction of the arrow 36, the direction the fastening element 40 is driven in, and would drive the fastening element 40 in the constructional component U. After the completion of the setting process, the control device 20 stops to feed current to the magnetic coil 12, and the restoring means 18 would displace the magnetic anchor 14 from its drive-in position 32 shown in FIG. 3 to its initial position 30 shown in FIG. 1.

Though the present invention was shown and described with references to the preferred embodiment, such is merely illustrative of the present invention and is not to be construed as a limitation thereof and various modifications of the present invention will be apparent to those skilled in the art. It is, therefore, not intended that the present invention be limited to disclosed embodiment or details thereof, and the present invention includes all variations and/or alternative embodiments within the spirit and scope of the present invention as defined by the appended claims.

1. An electromagnetically driven setting tool for driving in fastening elements, comprising a housing (11); a guide (13) arranged, at least partially, in the housing (11); a magnetic anchor (14) displaceably arranged in the guide (13); a magnetic coil (12) arranged in the housing (11) for displacing the magnetic anchor (14) from an initial position (30) of the magnetic anchor (14) relative to the housing (11) into an end position (32) in which the magnetic anchor (14) drives a fastening element (40) in; and a force accumulator (15) which becomes loaded by the magnetic anchor (14) when the magnetic anchor (14) is displaced, in a first phase of a setting process, by the magnetic coil (12) in a direction of the force accumulator (15) to an intermediate position (31) of the magnetic anchor (14) relative to the housing (11), and which accelerates the magnetic anchor (14), in a second phase of the setting process, in an opposite direction when the magnetic anchor (14) is displaced by the magnetic coil (12) from the intermediate position (31) to the end position (32).

2. A setting tool according to claim 1, further comprising a control device (20) which applies, in the first phase of the setting process, a first polarity to the magnetic coil (12) for accelerating the magnetic anchor (14) in the direction of the force accumulator (15), and which applies, in the second phase of the setting process, a second, reverse polarity to the magnetic coil (12) for accelerating the magnetic anchor (14) in the opposite direction.

3. A setting tool according to claim 1, wherein the force accumulator (15) is formed as a compression spring having one end (16) thereof fixedly secured to the housing (11) and an opposite end (17) of which, adjacent to the magnetic anchor (14), remains free.

4. A setting tool according to claim 1, wherein the magnetic anchor (14) is located, in the initial position (30) thereof, in a region of the guide (13) which is substantially surrounded by the magnetic coil (12).

5. A setting tool according to claim 1, wherein the magnetic anchor (14) is formed as a piston.

6. A setting tool according to claim 1, further comprising restoring means (18) for returning the anchor (14) from the end position (32) thereof to the initial position (30) thereof.

7. A setting tool according to claim 5, wherein the restoring means (18) is formed as a tension spring.

8. A method of driving an electromagnetically driven setting tool for driving in fastening elements and including a housing (11), a guide (13) arranged, at least partially, in the housing (11), a magnetic anchor (14) displaceably arranged in the guide (13), and a magnetic coil (12) arranged in the housing (11) for displacing the magnetic anchor (14) from an initial position (30) of the magnetic anchor (14) relative to the housing (11) into an end position (32) in which the magnetic anchor (14) drives a fastening element (40) in, the method comprising the steps of providing a force accumulator (15); applying, in a first phase of a setting process, a fist polarity to the magnetic coil (12) for accelerating the magnetic anchor (14) in a direction of the force accumulator (15) for preloading same; and applying, in a second phase of the setting process, a second reversed polarity to the magnetic coil (12) for displacing the magnetic anchor in an opposite direction, whereby the force accumulator (15), upon unloading, accelerates the magnetic anchor (14) in the opposite direction.
